(19) United States
(12) Patent Application Publication
(10) Pub. No.: US 2002/0075783 A1
(43) Pub. Date: Jun. 20, 2002

(54) Switchable liquid crystal diffractive element

(76) Inventors: Amir Alon, Sunnyvale, CA (US); Tatiana Tania Kosoburd, Ganei Aviv (IL); Shlomo Shapira, Petach-Tikva (IL); Michael Naor, Rehovot (IL); Joseph Kedmi, Jerusalem (IL)

Correspondence Address: FISH & NEAVE, 1251 AVENUE OF THE AMERICAS, 50TH FLOOR, NEW YORK, NY, 10020-1105, US

(21) Appl. No.: 09/866,002

(22) Filed: May 25, 2001

Related U.S. Application Data
(63) Continuation-in-part of application No. 09/026,736, filed on Feb. 20, 1998.

(51) Int. Cl. G11B 7/135

(52) U.S. Cl. 369/112.02

(57) ABSTRACT

A switchable liquid crystal diffractive element for use in an optical drive capable of reading multiple tracks of an optical disk simultaneously, and writing or erasing at least one track of the optical disk is disclosed. When the liquid crystal diffractive element is in an “on” state, it splits an incident beam into multiple beams suitable for simultaneously reading multiple tracks of an optical disk. When the liquid crystal diffractive element is in an “off” state, it permits an incident beam to pass through without being split, for writing to an optical disk. Embodiments are disclosed that use multiple electrodes to create switching and non-switching regions of a liquid crystal element to form a switchable phase grating, and that use a single switching liquid crystal element and a non-switching grating, or a birefringent non-switching grating, to form a switchable diffractive element.

### REFERENCE TO RELATED APPLICATIONS

The present application is a continuation-in-part of U.S. patent application Ser. No. 09/026,736, filed Feb. 20, 1998.

### FIELD OF INVENTION

The present invention relates to a switchable liquid crystal diffractive element for use in an optical drive that uses multiple beams to read data from an optical disk, and at least one beam to write data to an optical disk.

Background of the Invention

Due to their high storage density, long data retention life, and relatively low cost, optical disks have become the predominant media format for distributing information. Large format disks, and more recently, DVD disks, have been developed for storing full length motion pictures. The compact disk (CD) format was developed and marketed for the distribution of musical recordings and has replaced vinyl records. High-capacity, read-only data storage media, such as CD-ROM and DVD-ROM, have become prevalent in the personal computer field, and the DVD format may soon replace videotape as the distribution medium of choice for video information.

Recently, relatively inexpensive optical disk writers and writeable optical media have become available, making optical disks popular as backup and archival storage devices for personal computers. The large storage capacity of writeable optical disks also makes them ideal for use in multimedia authoring and in other applications that require access to large amounts of storage. Current writeable optical disk technologies include several write-once technologies, such as CD-Recordable (CD-R) and DVD-Recordable (DVD-R); a few technologies permit writing, erasing, and rewriting data on a disk, such as Mini-Disk (MD), which uses magneto-optical technology; still others use phase-change and dye-polymer technology. Recent advances in writeable optical disk technology have made rewriteable optical media more practical, and the specifications for DVD-RAM and DVD+RW call for use of high-capacity rewriteable optical media.

An optical disk is made of a transparent disk or substrate in which data, in the form of a serial bit-stream, are encoded as a series of pits in a reflective surface within the disk. The pits are arranged along a spiral or circular track. Data are read from the optical disk by focusing a low power laser beam onto a track on the disk and detecting the light reflected from the surface of the disk. By rotating the optical disk, the light reflected from the surface of the disk is modulated by the pattern of the pits rotating into and out of the field of laser illumination. Optical and imaging systems detect the modulated, reflected, laser light and produce an electrical signal that is decoded to recover the digital data stored on the optical disk.

Data is typically recorded on writeable optical disks by using a higher power laser than is used for reading. The media for use with optical disk writers typically includes a recording layer, made of a material that changes its optical characteristics in response to the presence of the beam from the high power laser. The high power laser is used to create “pits” in the recording layer that have a different reflectivity than surrounding areas of the disk, and that can be read using a lower power reading beam. In systems having the ability to erase and re-record data, a laser having a power output between the low power used for reading and the high power used for writing may be used to erase data. Alternatively, some systems employ a laser that outputs a different wavelength of light to erase data from the optical media. The methods used to write and erase optical disks depend on the type of recordable media being used.

To write or retrieve data from an optical disk, the foregoing optical systems include a pickup assembly that may be positioned to read or write data on any disk track. Servo mechanisms are provided for focusing the optical system and for keeping the pickup assembly positioned over the track, despite disk warpage or eccentricity.

Because in most previously known systems the data are read from the disk serially, i.e. one bit at a time, the maximum data transfer rate for an optical disk reader is determined by the rate at which the pits pass by the pickup assembly. The linear density of the bits and the track pitch are fixed by the specification of the particular optical disk format. For example, CD disks employ a track pitch of 1.6 μm, while DVD employs a track pitch only about one-half as wide.

One way to provide faster optical disk readers is to read multiple data tracks simultaneously, as described in commonly assigned U.S. Pat. No. 5,426,623 to Alon et al. In accordance with the methods and apparatus provided therein, for example, ten adjacent data tracks may be read simultaneously using a single wide-area beam. Thus, even if the disk is rotated at only 8× the standard speed, the capability to read ten tracks simultaneously provides the equivalent of an 80× drive.

It should be noted that as used herein, a data track is a portion of the spiral data track of a typical optical compact disk which follows the spiral for one rotation of the disk. Thus, a drive capable of reading multiple data tracks simultaneously reads multiple such portions of the spiral data track at once. For optical disks having concentric circular tracks, a data track would refer to one such circular track. For disks having multiple concentric spiral tracks, a data track would refer to one of the concentric spiral tracks.

Alternatively, multiple data tracks may be read simultaneously using multiple beams, arranged so that each beam illuminates a single data track on the disk. U.S. Pat. No. 5,144,616 to Yasukawa et al. shows a system in which multiple laser diode emitters are used to provide multiple beams. Commonly assigned U.S. Pat. No. 5,907,526 describes the use of a diffractive element to split an illumination beam into a plurality of reading beams having the proper spacing to align with the data tracks of an optical disk. Commonly assigned U.S. Pat. No. 5,917,797, for example, describes an optical element suitable for generating a two-dimensional array of beams.

These methods of increasing the speed by handling multiple tracks at once have generally only been used for optical disk readers, since writing multiple tracks of an optical disk simultaneously presents greater challenges. For example, whereas an optical disk reader that reads multiple tracks simultaneously must provide illumination for multiple tracks, an optical disk writer that writes multiple tracks simultaneously must control multiple lasers, which must be individually modulated according to the data being written.

More recently, optical disk writers and readers are being combined, so that the same drive may be used both to read and write optical disks. Such drives, however, are generally not as fast at reading optical disks as are dedicated optical disk readers. Many of the enhancements that increase the speed of optical disk readers are difficult to apply in a system that also writes optical disks. Fast CD-R drives are typically capable of recording at 4× speed and reading at 8× speed, while CD-ROM readers with speeds of 16× and faster (using constant linear velocity) are readily available. Consumers are thus left with a choice of purchasing a high speed CD-ROM reader, or a relatively low speed drive that can both read and write CD-ROMs.

Increasing the reading speed by using a diffractive element to split a single beam into multiple beams presents difficulties in a system that can write to an optical disk, since the diffractive element would be present both when reading and writing. The data written to a disk is typically controlled by modulating the beam that is used to write to the disk. If a diffractive element were used to split the modulated writing beam into multiple beams, all of the resulting beams would have the same modulation. Since the diffractive element splits the energy in the beam between the tracks, there may not be enough energy in any of the beams to write data to the disk. Moreover, even if the multiple beams had enough energy to write to the disk, because all of the beams would have the same modulation, all of the tracks on which the beams are focused may have the same data written to them.

To accommodate both reading and writing, a drive that uses a diffractive element to split a beam into multiple beams that are used to simultaneously read multiple tracks of an optical disk must have the ability to effectively remove the diffractive element from the optical path when writing an optical disk. Such a drive must be able to turn the diffractive element “on” during reading, and “off” during writing.

In view of the above, it would be desirable to provide a diffractive element for use in an optical drive, the diffractive element having two modes: a read mode, in which the diffractive element splits a beam of light into multiple reading beams; and a write mode, in which the beam of light is not affected by the diffractive element.

It would further be desirable to provide an optical system for use in an optical drive, the optical system capable of quickly switching between a read mode, in which a diffractive element is used to split a single beam of light into multiple reading beams, and a write mode, in which the beam of light is not split into multiple beams.

### SUMMARY OF THE INVENTION

It is an object of the present invention to provide a diffractive element for use in an optical drive, the diffractive element having two modes: a read mode, in which the diffractive element splits a beam of light into multiple reading beams; and a write mode, in which the beam of light is not affected by the diffractive element.

It also is an object of the invention to provide an optical system for use in an optical drive, the optical system capable of quickly switching between a read mode, in which a diffractive element is used to split a single beam of light into multiple reading beams, and a write mode, in which the beam of light is not split into multiple beams.

These and other objects of the present invention are achieved by providing a liquid crystal diffractive element for use in an optical disk drive that can write (or erase) data from at least one track of an optical disk, or simultaneously read multiple tracks of an optical disk. The liquid crystal diffractive element may be turned “on” during a read mode of operation, splitting a beam into a plurality of reading beams, each of which is focused onto a track of an optical disk. In a write (or erase) mode of operation, the liquid crystal diffractive element can be turned “off”, permitting the beam to pass through the liquid crystal diffractive element without being split. Use of liquid crystal permits relatively rapid switching between read and write modes.

A first preferred embodiment of the present invention uses a liquid crystal element having switching and non-switching regions arranged to form a grating pattern. When a driving voltage is “off”, in write mode, the molecules of the liquid crystal are oriented parallel to a substrate surface, and all grating patterns have the same optical properties for light polarized in a direction parallel to an “extraordinary” axis of the liquid crystal, which is parallel to the orientation of the molecules. In this mode, the liquid crystal element permits a writing beam to pass through without being split. When the driving voltage is applied to the switching regions, in read mode, the molecules in the switching regions are oriented perpendicular to the substrate surface, and the switching regions will have an index of refraction equal to an “ordinary” index of refraction for light polarized in any direction. In this mode, since adjacent grating patterns have different indices of refraction, a beam passing through the liquid crystal diffractive element will be split into a plurality of reading beams.

In a second preferred embodiment of the present invention, the liquid crystal has switching regions made of individually addressable pixels. This enables individual pixels to be switched to dynamically alter the properties of the grating. For example, the LCD pixels may be switched to provide a grating having first set of properties when a CD is being read, and a second set of properties when a DVD is being read.

In alternative embodiments , the diffractive element includes a relief surface. The relief surface comprises a grating, and is formed by etching, injection molding, or any other technology, in a material having an index of refraction substantially the same as an “extraordinary” index of refraction of the liquid crystal. In write mode, an incident beam of light, polarized parallel to the extraordinary axis of the liquid crystal, will not be modulated by the grating, and will not be split. In read mode, a driving voltage is applied, and the molecules of the liquid crystal rotate to a direction perpendicular to the substrate, and the index of refraction of the liquid crystal is equal to the “ordinary” index of refraction. Since the index of refraction of the liquid crystal is different than the index of refraction of the relief surface, an incident beam of light will be split into a plurality of reading beams.

Alternatively, the relief surface may comprise a material matching the ordinary index of refraction of the liquid crystal. In this case, when the driving voltage is off, the system is in read mode, and when the driving voltage is on, the system is in write mode.

Another preferred embodiment uses a diffractive element constructed from a birefringent material and a switchable liquid crystal λ/2 plate disposed in the optical path before the diffractive element. When the system is in write or erase mode, the liquid crystal plate polarizes light beams in a direction parallel to the extraordinary axis of the diffractive element, permitting the beams to pass through the diffractive element without being split into multiple reading beams. When the system is in read mode, the liquid crystal plate polarizes the light beams in a direction 90° from the extraordinary axis of the diffractive element, causing the beams to be split into multiple reading beams.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 shows a previously known multi-beam optical pickup that uses a diffractive element to split a beam of light into multiple reading beams;

FIG. 2 shows an optical system built in accordance with the principles of the present invention, using a liquid crystal diffractive element;

FIG. 3 shows a first preferred embodiment of a switchable diffractive element built in accordance with the principles of the present invention;

FIG. 4 is a graph showing the grating relief of a diffractive element that splits a beam of light into seven beams;

FIG. 5 shows an alternative preferred embodiment of a switchable diffractive element built in accordance with the principles of the present invention;

FIG. 6 shows another alternative preferred embodiment of a switchable diffractive element; and

FIGS. 7 and 8 show optical systems built in accordance with the principles of the present invention, using the switchable diffractive element shown in FIG. 6.

### DETAILED DESCRIPTION OF THE INVENTION

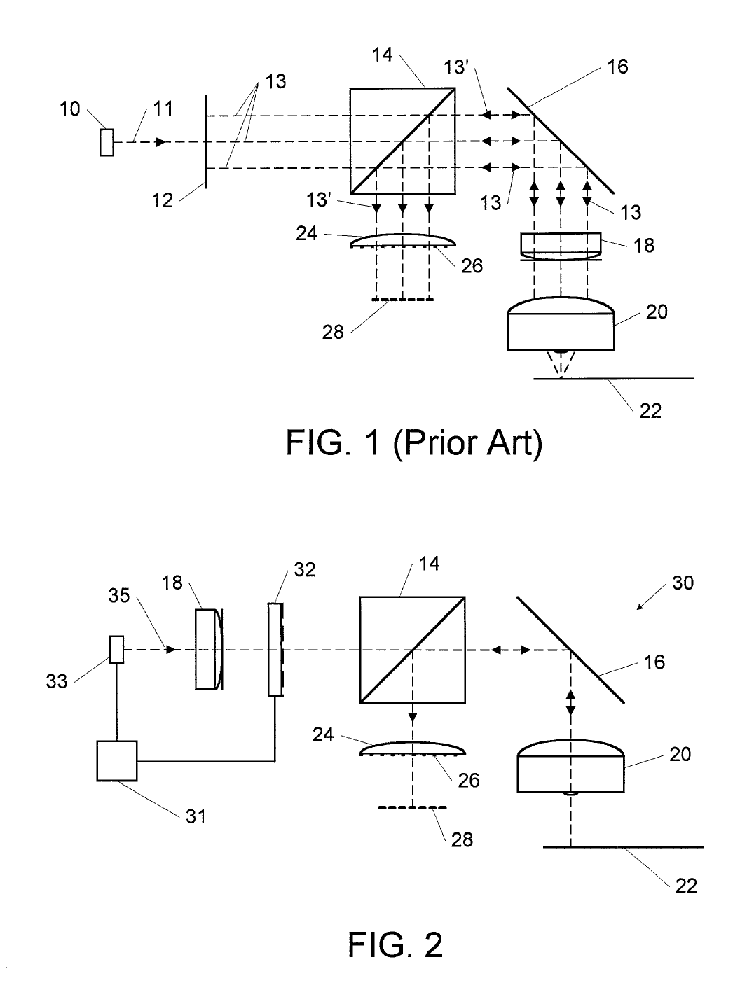

Referring to FIG. 1, a previously known multi-beam optical pickup that employs a diffractive element to generate multiple reading beams is described. Laser diode 10 generates illumination beam 11 that passes through diffractive element 12 and is split into a plurality of reading beams 13. Reading beams 13 pass through beamsplitter 14, and are reflected by mirror 16 toward collimator 18 and objective 20, which focuses the beams onto a surface of optical disk 22.

Reading beams 13 are reflected from a data-bearing surface of optical disk 22, modulated by the data recorded on a plurality of tracks of optical disk 22 to form light beams 13′. The reflected, modulated beams 13′ again pass through objective 20 and collimator 18, and are directed back to beamsplitter 14 by mirror 16. Beamsplitter 14 directs beams 13′ through tube lens 24 and holographic element 26 onto detector array 28. Detector array 28 comprises a plurality of photo-detector elements 29. Each photo-detector element 29 detects the modulation of a corresponding light beam 13′ to thereby read the data from a track of the optical disk. Signals output by detector array 28 also may be used to detect errors in the focus and tracking of the optical disk reader.

A multi-beam optical disk reader, as described above, is capable of achieving very high speeds when reading an optical disk. A seven beam reader, for example, which rotates the disk at 8× standard speed, provides a data rate equivalent to a 56× drive. Thus, simultaneously reading multiple tracks of an optical disk provides significant increases in data reading rates at relatively low spindle speeds, as compared to optical systems that read a single track.

Previously known optical disk writing systems employ an optical path similar to that shown in FIG. 1, except only a single beam is typically used, and diffractive element 12 is omitted. Instead of reading data from the disk, an optical disk writer pulses the laser diode on and off to write data to the disk. The laser diode used in an optical disk writer is capable of generating a higher power beam than the laser diode of an optical disk reader. For example, while reading may require a light beam having a power of 1 mW, writing data to an optical disk may require a light beam having a power in the range of 10 to 12 mW, depending upon the specific technology employed. Many optical disk writers also may produce a light beam having an intermediate power used to erase areas of the writeable optical media. Such a light beam may, for example, have a power of 4 to 8 mW.

As seen above, when reading an optical disk, it is desirable to use multiple reading beams, so that multiple tracks may be simultaneously read. These beams may be generated using a diffractive element in the optical path. When writing a disk, however, the writing beam must not be split into multiple beams by a diffractive element, since each track of the optical disk should have different data written on it. An optical drive that simultaneously writes multiple tracks of an optical disk should use multiple laser diodes, so that each of the beams may be individually modulated.

Thus, building an optical pickup that can be used either to simultaneously read multiple tracks of an optical disk, or write at least one track of an optical disk presents difficulties. When the optical pickup is reading data from a disk (“read mode”), it is desirable to have a diffractive element in the optical path, to split an illumination beam into a plurality of reading beams. However, when the optical pickup is being used to write data to a disk (“write mode”), the diffractive element must not be in the optical path, and the illumination beam should not be split.

One approach to solving this problem is to add a mechanical system to the optical pickup, that can move diffractive element 12 into the optical path during read mode, and move diffractive element 12 out of the optical path during write mode. This solution may be technically challenging because mechanical movement of the diffractive element may be relatively slow, and positioning the diffractive element with a high degree of precision may be difficult to achieve.

In accordance with the principles of the present invention, the same effect—placing a diffractive element in the optical path during read mode, and removing the diffractive element during write mode, may be achieved using a switchable liquid crystal diffractive element. In FIG. 2, an optical system built using a switchable liquid crystal diffractive element is show. In optical system 30, diffractive element 12 is replaced by liquid crystal diffractive element 32. Processor 31 controls the operation of laser diode 33 as well as the application of an electric field to liquid crystal diffractive element 32.

As is well known, in the presence of an electric field, nematic liquid crystal is capable of undergoing a change in refractive index for light polarized in a direction parallel to an “extraordinary” axis. This is caused by a rotation of molecules of the liquid crystal in the presence of an electric field. Since nematic liquid crystal is a birefringent material, in the absence of an electric field it has a different index of refraction along the “extraordinary” axis, parallel to the orientation of the molecules, than along the “ordinary” axis, perpendicular to the extraordinary axis. When a voltage is applied, the molecules of the liquid crystal rotate to a direction perpendicular to a substrate surface, and the liquid crystal loses its birefringent properties for light polarized in a direction parallel to the substrate surface. This effectively causes a change in the index of refraction for light polarized in a direction parallel to the initial direction of the molecules. Liquid crystal diffractive element 32 exploits this property to provide a switchable diffractive element.

Liquid crystal diffractive element 32 therefore functions as a beamsplitter that splits light beam 35 output by laser diode 33 into multiple reading beams for one amplitude of an applied electric field, and permits most of light beam 35 to pass unaffected through the liquid crystal for another or zero amplitude of the electric field. By turning liquid crystal diffractive element 32 “on” during read mode, light beam 35 from laser diode 33 is split into multiple reading beams, thereby enabling the system to simultaneously read a plurality of tracks on optical disk 22. During write mode, when data is being written or erased, liquid crystal diffractive element 32 is turned “off”, thus allowing light beam 35 from laser diode 33 to pass through without being split into multiple beams.

As will be apparent from the foregoing, laser diode 33 must generate light beam 35 to have sufficient power to read data from optical disk 22 after the beam has been split into multiple reading beams, and to write or erase data on optical disk 22. It is expected that a liquid crystal diffractive element having a switching time of 20 microseconds or less will provide sufficient speed for most applications that require rapid switching between reading and writing modes of operation. Additionally, although only one laser diode is shown in the system of FIG. 2, multiple laser diodes may be used in write mode to simultaneously write multiple tracks of an optical disk.

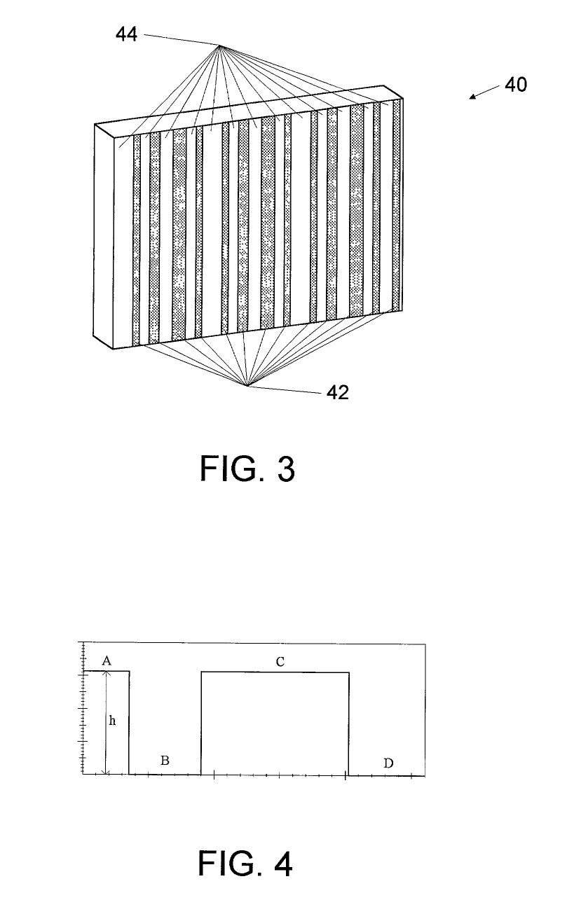

Referring now to FIG. 3, a first embodiment of a liquid crystal diffractive element built in accordance with the principles of the present invention is shown. Liquid crystal diffractive element 40 comprises a liquid crystal element that is divided into two sets of regions: switching regions 42; and non-switching regions 44. When an electric field is applied, switching regions 42 change the direction of the liquid crystal molecules, effectively changing the index of refraction of the switching regions for light polarized in a direction parallel to the initial orientation of the molecules, thereby modulating the phase of light passing through liquid crystal diffractive element 40, and providing an effective phase grating. When no electric field is applied, switching regions 42 and non-switching regions 44 have substantially the same optical properties, and do not produce a spatial modulation of the phase of light passing through liquid crystal diffractive element 40.

Liquid crystal diffractive element 40 preferably comprises a nematic liquid crystal, such as a mixture of pentylphenyl-para-metoxibenzoat and hexilphenyl-flour-zian-benzoat. One skilled in the art will recognize that there are many other nematic liquid crystals that could be used. Alternatively, liquid crystal diffractive element 40 may comprise a ferroelectric liquid crystal element, a polymer-dispersed liquid crystal material, or other types of liquid crystal. As will be understood by one skilled in the art, use of other types of liquid crystal may require some minor modifications. For example, since the molecules of a ferroelectric liquid crystal have a relatively low maximum rotation angle, all of the regions of the above-described embodiment would need to be switchable to achieve a 45° difference in molecule orientation between adjacent grating patterns, a first set of regions (referred to above as switching regions) would have a field applied to rotate the molecules by 22.5°, while a second set of regions (referred to above as the non-switching regions) would have a field applied to rotate the molecules by −22.5°. Thus, in a ferroelectric liquid crystal version of the above-described embodiment, all the regions are switchable.

When liquid crystal diffractive element 40 is “on” (i.e. when an electric field is applied to the switching regions), it acts as a diffractive element, splitting an illumination beam into a plurality of reading beams. When liquid crystal diffractive element 40 is “off”, it is essentially transparent to a laser beam used for writing or erasing a disk, causing only a negligible loss of optical efficiency.

When liquid crystal diffractive element 40 is “on”, it behaves in a manner nearly identical to a normal phase grating, except that the polarization will have an effect on the energy distribution in the reading beams. Light polarized parallel to the extraordinary axis will have maximal phase modulation, while light having a polarization parallel to the ordinary axis will not be modulated by the grating. Similarly, if beamsplitter 12 is a polarizing beamsplitter, the energies of the reading beams will depend on the polarization axis of beamsplitter 12.

In a preferred embodiment, the polarization axis of light beam 35 will be parallel to the extraordinary axis of liquid crystal diffractive element 40. Additionally, the extraordinary axis of liquid crystal diffractive element 40 should be oriented in a direction parallel to the direction of polarization of light that is effectively transmitted by beamsplitter 12, if beamsplitter 12 is a polarizing beamsplitter. This configuration will lead to minimal loss of beam power in both read and write modes.

There are several conditions that must be met by an optical system that includes liquid crystal diffractive element 40. First, the element must produce a single beam in write mode, and that beam must have enough energy to write to the disk. Note that in systems that permit erasing, the beam energy is simply decreased to match the erase energy while liquid crystal diffractive element 40 remains in write mode. In read mode, all of the reading beams must have at least enough energy to read the disk, and none of the reading beams may have enough energy to write or erase the disk. Ideally, the energy of each of the reading beams will be approximately equal, with the exception of a central reading beam (the 0-order beam), which may have a slightly greater energy, since it may be used for focusing and tracking, as well as for reading the disk.

In a preferred embodiment that uses seven reading beams to simultaneously read seven tracks of an optical disk, and in which the minimum reading energy is approximately 1 mW, the minimum erasing energy is approximately 5 mW, and the minimum writing energy is approximately 10 mW, switchable liquid crystal grating 40 will have a grating parameter relief as shown in FIG. 4. Regions “A” and “C” correspond to switching regions 42 of switchable liquid crystal grating 40 when in write mode, while regions “B” and “D” correspond to non-switching regions 44. The length of each of these regions is given in table 1, whereas the “height” of the regions depends on the particular embodiment.

TABLE 1
Grating Parameters

| Parameter | Value |
|---|---|
| A | 35 |
| (in microns) | |
| B | 55.5 |
| (in microns) | |
| C | 112.5 |
| (in microns) | |
| D | 57 |
| (in microns) | |
| Period | 260 |
| (in microns) | |

A diffractive element having these parameters in read mode produces seven reading beams (diffractive orders −3, −2, −1, 0, 1, 2, and 3). In a preferred embodiment of the optical pickup, these beams produce a spacing of approximately 8 microns between illumination spots when projected onto the surface of the optical disk by an objective lens having a 3.05 mm focal length. In an ideal system, in which the light is polarized as described hereinabove, and in which a polarizing beam splitter is used, as described hereinabove, the beam energy in write mode will be approximately 18 mW, using a laser diode power of approximately 50 mW. In read mode, the reading beams will have the energies shown in table 2, using a laser diode power of approximately 23 mW.

TABLE 2
Read Mode Beam Energy

| Diffractive Order | Energy (in mW) |
|---|---|
| −3 | 1.07 |
| −2 | 1.05 |
| −1 | 1 |
| 0 | 3 |
| 1 | 1 |
| 2 | 1.05 |
| 3 | 1.07 |

As can be seen in table 2, each of the reading beams has energy at least equal to the minimum read energy (1 mW), none of the beams has energy greater than the minimum erase energy (5 mW), and all of the beams are approximately equal in energy, except the central beam (order 0), which has a higher energy than the other beams. Thus, the required conditions for liquid crystal diffractive element 40 are met in an ideal system.

A real system differs from the ideal in several respects. First, liquid crystal is typically enclosed between two glass surfaces, each of which is covered with one or more transparent electrodes that are used to generate electric fields that turn the liquid crystal device “on” or “off”. The liquid crystal, the surfaces, and the electrodes, when combined, transmit only approximately 80% of the incident light (the remaining 20% is reflected or absorbed), reducing the efficiency of the system. Additionally, since the phase modulation introduced by liquid crystal diffractive element 40 depends on the depth of the liquid crystal, there are minor losses in efficiency due to manufacturing tolerances of approximately ±10% in the depth of the liquid crystal. The temperature also affects the change in polarization, and may cause minor losses in efficiency.

An additional difference in efficiency division between a real liquid crystal diffractive element built in accordance with the principles of the above-described embodiment of the invention and an ideal element may be caused by manufacturing tolerances for the electrodes, and by transition of the electric field. The electric field generated by the electrodes of the switching regions may extend slightly beyond the switching regions. This may create “transition regions” between the switching and non-switching regions of the liquid crystal element, causing a change in the phase profile of the element. Furthermore, even when the element is “off”, the electrodes, which have a different index of refraction than the liquid crystal, may cause some phase modulation.

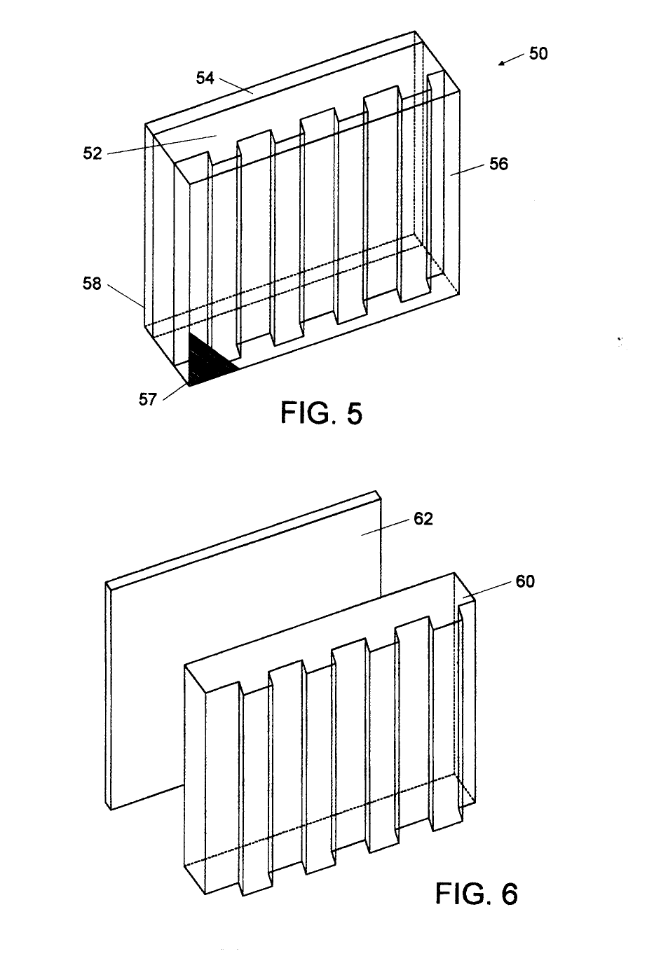

Referring now to FIG. 5, an alternative preferred embodiment of a switchable liquid crystal diffractive element built in accordance with the principles of the present invention is shown, in which a diffractive element is immersed in liquid crystal. Advantageously, liquid crystal diffractive element 50 does not have difficulties caused by transition areas, since it has no transition areas.

Liquid crystal diffractive element 50 comprises nematic liquid crystal 52, disposed between plane plate 54 and relief plate 56. Plane plate 54 is covered by a single transparent electrode 57, shown only in part in FIG. 5 to improve clarity. Similarly, an outer surface of relief plate 56 is covered by transparent electrode 58. Thus, all the diffraction patterns of liquid crystal diffractive element 50 have a common pair of electrodes 57 and 58 that generates the required electric field. Since there is only one pair of electrodes for all the diffraction patterns, there are no adjacent electrodes, and no transition regions.

In write mode, when a single beam is required, the extraordinary axis of nematic liquid crystal 52 is aligned in a direction parallel to the polarization direction of incident light. Relief plate 56 is manufactured of a material, such as PMMA (poly-methil-methacrylate), chosen to match the index of refraction of nematic liquid crystal 52 (nₑₓ) for polarization parallel to the extraordinary axis. In this case, relief plate 56 does not modulate the phase of the incident light, and the writing beam is not split.

Alternatively, relief plate 56 may be manufactured with a relief height of (λ×m)/(nₑₓ−1), where λ is the wavelength of the incident light, m is an integer, and nₑₓ is the index of refraction of the material from which relief plate 56 is manufactured. This relief height will insert phase proportional to 2π for light polarized parallel to the extraordinary axis, which is equivalent to the absence of relief plate 56. As above, an incident light beam is not split by liquid crystal diffractive element 50, and may be used for writing or erasing.

In read mode, a driving voltage is applied to nematic liquid crystal 52 through electrodes 57 and 58, so the molecules of the liquid crystal are rotated perpendicular to the substrate plane, and the index of refraction of nematic liquid crystal 52 changes. Since the index of refraction of nematic liquid crystal 52 is no longer the same as the index of refraction of relief plate 56, light passing through liquid crystal diffractive element 50 will be split into a plurality of reading beams.

In a similar alternative embodiment, the material of relief plate 56 can be chosen to match the ordinary index of refraction (nₒ) of liquid crystal 52, so that liquid crystal diffractive element 52 is in read mode when no voltage is applied, and switches to write or erase mode when a driving voltage is applied. Alternatively, as above, relief surface 56 may be designed so that the relief height is (λ×m)/(nₒ−1), where λ is the wavelength of the incident light, m is an integer, and nₒ is the ordinary index of refraction of liquid crystal 52.

Advantageously, liquid crystal diffractive element 50 has only a single electrode on each substrate (i.e. plane plate 54 and relief plate 65), so there are no transition regions, and the electrodes do not act as grating patterns. Additionally, the operation of liquid crystal diffractive element 50 does not depend on depth tolerances of liquid crystal 52.

FIG. 6 shows another preferred embodiment that achieves efficiencies similar to the embodiment described above with reference to FIG. 5. In this embodiment, diffractive element 60 is manufactured in a birefringent material, such as calcite or titanium dioxide, which may not be switched “on” or “off”. Liquid crystal plate 62 is placed in the optical path prior to diffractive element 60, so that its ordinary and extraordinary axes have angles of ±45° to the direction of polarization of incident light. Liquid crystal plate 62 may comprise a standard λ/2 nematic liquid crystal plate, or any other switchable λ/2 waveplate.

Since diffractive element 60 is manufactured of a birefringent material, it also has ordinary and extraordinary axes. The extraordinary axis of the birefringent material of diffractive element 60 is oriented at an angle of 45° from the extraordinary axis of liquid crystal plate 62.

The grating patterns of diffractive element 60 are designed so that they have a height of (λ×m)/(nₑₓ−1), where λ is the wavelength of incident light, m is an integer, and nₑₓ is the extraordinary index of refraction of diffractive element 60. This inserts phase proportional to 2π for light polarized in a direction parallel to the extraordinary axis of diffractive element 60.

In write mode (or erase mode), liquid crystal plate 62 polarizes the light in a direction parallel to the extraordinary axis of diffractive element 60. Diffractive element 60 therefore inserts a phase difference proportional to 2π, having essentially no effect on the writing or erasing beam.

In read mode, liquid crystal plate 62 is switched “on”, and rotates the polarization of the light by 90° from the direction of polarization used in write mode. Thus, the light is polarized in a direction parallel to the ordinary axis of diffractive element 60, and is diffracted by diffractive element 60, splitting the light into multiple reading beams.

In an alternative embodiment, the grating patterns of diffractive element 60 are designed so that they have a height of (λ×m)/(nₒ−1), where λ is the wavelength of incident light, m is an integer, and nₒ is the ordinary index of refraction of diffractive element 60. This embodiment inserts phase proportional to 2π for light polarized in a direction parallel to the ordinary axis of diffractive element 60. Thus, in read mode, liquid crystal plate 62 polarizes light in a direction parallel to the extraordinary axis, causing a beam to be split into numerous reading beams by diffractive element 60. In write mode, liquid crystal plate 62 polarizes light in a direction parallel to the ordinary axis, so the light is not split by diffractive element 60.

One difficulty with the preferred embodiment described with reference to FIG. 6 appears in systems that use a polarizing beamsplitter and λ/4 plate to increase the optical efficiency of the system. If the polarizing beamsplitter is placed in the optical path after the diffractive element, light must be polarized in the proper direction for passing through the beamsplitter after the diffractive element. In the preferred embodiment described with reference to FIG. 6, after the diffractive element, the light will have a different direction of polarization in write mode than in read mode. This problem may be solved by adding an additional switchable λ/2 waveplate in the optical path, for rotating the polarization after the grating. Use of this additional switchable waveplate is synchronized with the read or write mode, so that light is polarized in the same direction in either mode.

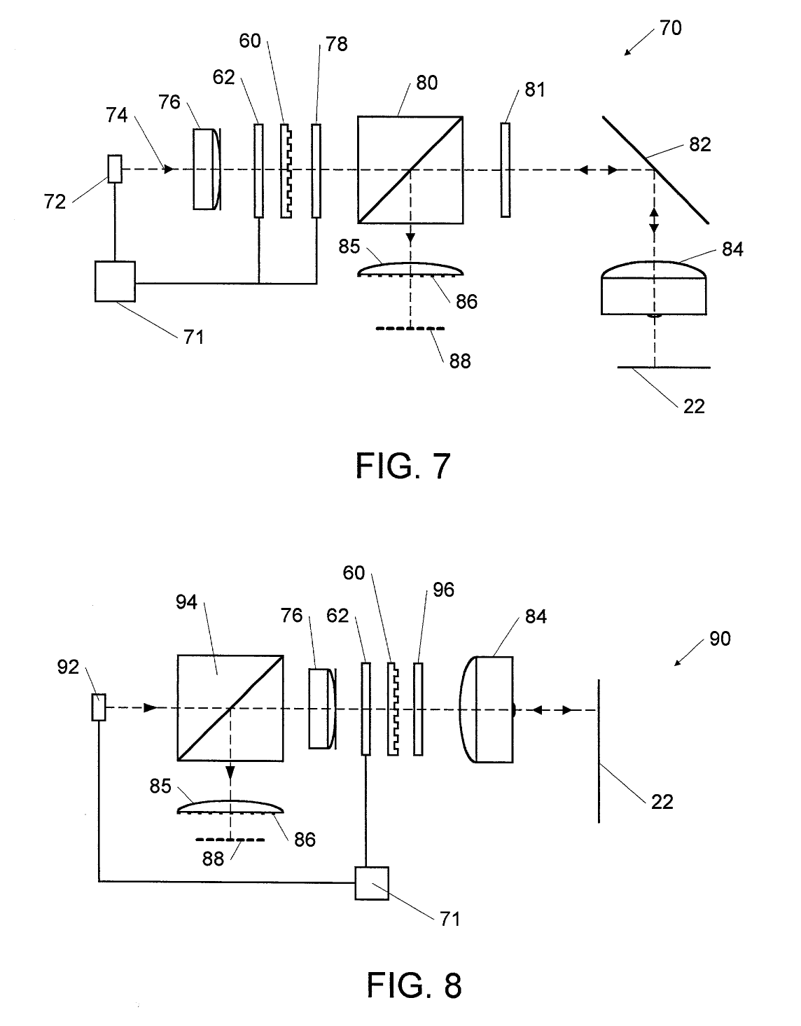

FIG. 7 shows an optical system built in accordance with the principles of the present invention using the preferred embodiment described with reference to FIG. 6, and an extra nematic liquid crystal λ/2 waveplate, which is switchable to adjust the polarization. Optical system 70 uses laser diode 72 to generate light beam 74. Light beam 74 passes through collimator 76, liquid crystal plate 62, and birefringent diffractive element 60. Liquid crystal plate 62 is controlled by processor 71, and aligns the polarization of light passing through it so that the light is polarized in a direction parallel to the axis of diffractive element 60 that produces phase modulation proportional to 2λ in write or erase mode. In read mode, liquid crystal plate 62 aligns the direction of polarization to a direction perpendicular to the direction used in write mode.

Due to the polarization of the light, in write or erase mode, diffractive element 60 does not split light beam 74, while in read mode, diffractive element 60 splits light beam 74 into a plurality of reading beams. The beam (or beams) then pass through switchable λ/2 waveplate 78, which is connected to processor 71 and synchronized with liquid crystal plate 62, and rotates the polarization of the light so that the polarization is the same for all modes of operation.

The light then passes through polarizing beamsplitter 80 and λ/4 waveplate 81, and is reflected by mirror 82 toward objective 84, which focuses the light onto a surface of optical disk 22. Light reflected by the surface of optical disk 22 again passes through λ/4 waveplate 81, and is directed by polarizing beamsplitter 80 through lens 85 and holographic element 86 onto detector array 88.

Alternatively, difficulties related to the polarization of light being different in read mode than in write or erase mode may addressed by placing liquid crystal plate 62 and diffractive element 60 in the optical path after the polarizing beamsplitter, as shown in FIG. 8. Light generated by one or more laser diodes 92 passes through polarizing beamsplitter 94, collimator 76 and liquid crystal plate 62 before passing through birefringent diffractive element 60. The light then passes through non-switchable λ/4 plate 96 before being focused by objective 84 onto a surface of optical disk 22. Light reflected from the surface of optical disk 22 passes back through non-switchable λ/4 plate 96, birefringent diffractive element 60 and liquid crystal plate 62, and is reflected by polarizing beamsplitter 94 towards lens 85 and holographic element 86 onto detector array 88.

Laser diodes 92, which preferably comprise three independently modulated laser diodes, permitting three tracks to be simultaneously written, generates light polarized in a direction that passes through polarizing beamsplitter 94 before possibly having its direction of polarization changed by liquid crystal plate 62. Light reflected from optical disk 22 has passed through non-switchable λ/4 plate 96 twice, and passes through liquid crystal plate 62 a second time before reaching polarizing beamsplitter 94.

Thus, when liquid crystal plate 62 is “on”, and rotates the polarization of the light by 90°, the direction of polarization of the light will be rotated by a total of 270° (90° for each pass through liquid crystal plate 62, and 90° for two passes through non-switchable λ/4 plate 96), and reflected by polarizing beamsplitter 94.

When liquid crystal plate 62 is “off”, and does not rotate the direction of polarization, the light will have its direction of polarization rotated by a total of 90° after two passes through non-switchable λ/4 plate 96), and will be reflected by polarizing beamsplitter 94. Thus, in either read or write mode, polarizing beamsplitter 94 will reflect the light towards detector array 88.

Advantageously, by placing diffractive element 60 close to objective 84, the outermost reading beams (i.e. the high order reading beams) will be better fill the aperture of objective 84. This will decrease the sizes of the spots projected onto optical disk 22. Additionally, since diffractive element 60 will split writing beams after they are reflected from optical disk 22, each of the beams directed towards detector array 88 (which is used for focusing and tracking in write mode) will have greatly decreased energy relative to the unsplit writing beam. This will permit use of focus and tracking detectors having a smaller dynamic range than in the system of FIG. 7. Further, since only one switchable waveplate (i.e. liquid crystal plate 62) is needed, the system of FIG. 8 may be less costly to manufacture than the optical system described with reference to FIG. 7.

Although preferred illustrative embodiments of the present invention are described above, it will be evident to one skilled in the art that various changes and modifications may be made without departing from the invention. For example, various components of the optical system may be changed or rearranged. It is intended in the appended claims to cover all such changes and modifications that fall within the true spirit and scope of the invention.

What is claimed is:

1. A switchable diffractive element for use in the optical system of an optical disk drive capable of reading multiple tracks of an optical disk simultaneously and writing a track of an optical disk, the switchable diffractive element comprising:
a liquid crystal element, the liquid crystal element having an “on” state and an “off” state, the switchable diffractive element splitting an illumination light beam into a plurality of reading light beams that are focused on multiple tracks of the optical disk when the liquid crystal element is in the “on” state, and passing the illumination light beam through the switchable diffractive element substantially without being split when the liquid crystal element is in the “off” state, the illumination light beam focused on a track of the optical disk when the liquid crystal element is in the “off” state.

2. The switchable diffractive element of claim 1, wherein the liquid crystal element comprises a first set of regions and a second set of regions, wherein an index of refraction of the first set of regions is substantially equal to an index of refraction of the second set of regions for light polarized in a selected direction when the liquid crystal element is in the “off” state, and the index of refraction of the first set of regions is not equal to the index of refraction of the second set of regions for light polarized in the selected direction when the liquid crystal element is in the “on” state.

3. The switchable diffractive element of claim 2, wherein the first set of regions and the second set of regions are arranged and sized to form a phase grating when the liquid crystal element is in the “on” state.

4. The switchable diffractive element of claim 2, wherein a polarization axis of the first set of regions is substantially the same as a polarization axis of the second set of regions when the liquid crystal element is in the “off” state, and wherein the polarization axis of the first set of regions is rotated relative to the polarization axis of the second set of regions when the liquid crystal element is in the “on” state.

5. The switchable diffractive element of claim 4, wherein the polarization axis of the first set of regions is rotated by 45° relative to the polarization axis of the second set of regions.

6. The switchable diffractive element of claim 1, wherein the liquid crystal element comprises a liquid crystal material inserted between a plane surface and a relief surface, the relief surface having grating patterns on a substrate with an index of refraction substantially equal to an index of refraction of the liquid crystal material for a selected polarization axis, the grating patterns splitting a beam into multiple beams having a predetermined efficiency division for a polarization axis perpendicular to the selected polarization axis.

7. The switchable diffractive element of claim 6, wherein the selected polarization axis is an extraordinary axis of the liquid crystal material.

8. The switchable diffractive element of claim 6, wherein the selected polarization axis is an ordinary axis of the liquid crystal material.

9. The switchable diffractive element of claim 6, wherein the predetermined efficiency division provides a central beam having greater energy than non-central beams.

10. The switchable diffractive element of claim 6, wherein an extraordinary axis of the liquid crystal material is substantially parallel to a polarization direction of the illumination light beam.

11. The switchable diffractive element of claim 6, wherein for the selected polarization axis, the grating patterns insert a phase difference between adjacent grating patterns substantially equal to 2π×m, where m is an integer.

12. The switchable diffractive element of claim 1, wherein the diffractive element further comprises a diffractive element manufactured of a birefringent material disposed after the liquid crystal element in an optical path of the illumination light beam, the liquid crystal element comprising a switchable λ/2 waveplate with ordinary and extraordinary axes aligned at angles of approximately ±45° from a direction of polarization of the illumination light beam, the birefringent material having an extraordinary axis oriented at an angle of approximately 45° from the extraordinary axis of the switchable λ/2 waveplate when no driving voltage is applied to the switchable λ/2 waveplate, the diffractive element having grating patterns that insert a phase difference in adjacent grating patterns substantially equal to 2π×m, where m is an integer, for light polarized parallel to a selected axis of the birefringent material, and wherein the diffractive element splits light having a direction of polarization perpendicular to the selected axis of the birefringent material.

13. The switchable diffractive element of claim 12, wherein the selected axis of the birefringent material is the extraordinary axis of the birefringent material.

14. The switchable diffractive element of claim 12, wherein the selected axis of the birefringent material is the ordinary axis of the birefringent material.

15. The switchable diffractive element of claim 12, wherein the liquid crystal element aligns the polarization direction of the illumination beam in a direction substantially parallel to the extraordinary axis of the birefringent material when the driving voltage is applied.

16. The switchable diffractive element of claim 1, wherein the liquid crystal element comprises a nematic liquid crystal element.

17. The switchable diffractive element of claim 1, wherein the liquid crystal element comprises a ferroelectric liquid crystal element.

18. A method of selectively reading multiple tracks of an optical disk simultaneously and writing a track of an optical disk for use in an optical disk, the method comprising:
generating an illumination light beam;
providing a switchable diffractive element comprising a liquid crystal element having an “on” state and an “off” state;
selectively switching to a read mode wherein the liquid crystal element is placed in the “on” state, and wherein the switchable diffractive element splits the illumination light beam into a plurality of reading light beams, each of which is focused onto a corresponding track of the optical disk; and
selectively switching to a write mode wherein the liquid crystal element is placed in the “off” state, and wherein the illumination light beam passes through the switchable diffractive element substantially without being split, the illumination light beam being focused on a track of the optical disk.

19. The method of claim 18, further comprising selectively switching to an erase mode wherein the liquid crystal element is placed in the “off” state, and wherein the illumination light beam passes through the switchable diffractive element substantially without being split, the illumination light beam having sufficient power to erase data from the optical disk, the illumination light beam being focused on a track of the optical disk.

20. The method of claim 18, wherein providing a switchable diffractive element comprises providing the liquid crystal element with a first set of regions and a second set of regions, wherein an index of refraction of the first set of regions is substantially equal to an index of refraction of the second set of regions for light polarized in a selected direction when the liquid crystal element is in the “off” state, and the index of refraction of the first set of regions is not equal to the index of refraction of the second set of regions for light polarized in the selected direction when the liquid crystal element is in the “off” state.

21. The method of claim 20, wherein providing a switchable diffractive element further comprises arranging and sizing the first set of regions and the second set of regions to form a phase grating when the liquid crystal element is in the “on” state.

22. The method of claim 18, wherein providing a switchable diffractive element comprises providing a switchable diffractive element wherein the liquid crystal element comprises a liquid crystal material inserted between a plane surface and a relief surface, the relief surface having grating patterns on a substrate with an index of refraction substantially equal to an index of refraction of the liquid crystal material for a selected polarization axis, the grating patterns splitting a beam into multiple beams having a predetermined efficiency division for a polarization axis perpendicular to the selected polarization axis.

23. The method of claim 22, wherein providing a switchable diffractive element comprises providing a switchable diffractive element wherein the selected polarization axis is an extraordinary axis of the liquid crystal material.

24. The method of claim 22, wherein providing a switchable diffractive element comprises providing a switchable diffractive element wherein the selected polarization axis is an ordinary axis of the liquid crystal material.

25. The method of claim 22, wherein generating the illumination light beam comprises generating the illumination light beam with a direction of polarization substantially parallel to the extraordinary axis of the liquid crystal material.

26. The method of claim 22, wherein providing a switchable diffractive element comprises providing a switchable diffractive element wherein for the selected polarization axis, the grating patterns insert a phase difference between adjacent grating patterns substantially equal to 2π×m, where m is an integer.

27. The method of claim 18, wherein providing a switchable diffractive element further comprises providing a diffractive element manufactured of a birefringent material disposed after the liquid crystal element in an optical path of the illumination light beam, the birefringent material having an extraordinary axis oriented at an angle of approximately 45° from an extraordinary axis of the liquid crystal element when no driving voltage is applied to the liquid crystal element, the diffractive element having grating patterns that insert a phase difference in adjacent grating patterns substantially equal to 2π×m, where m is an integer, for light polarized parallel to a selected axis of the birefringent material, and wherein the diffractive element splits light having a direction of polarization perpendicular to the selected axis of the birefringent material.

28. The method of claim 27, wherein providing a diffractive element comprises providing a diffractive element wherein the selected axis of the birefringent material is the extraordinary axis of the birefringent material.

29. The method of claim 27, wherein providing a diffractive element comprises providing a diffractive element wherein the selected axis of the birefringent material is an ordinary axis of the birefringent material, perpendicular to the extraordinary axis of the birefringent material.

30. The method of claim 27, further comprising using the liquid crystal element to rotate the polarization axis of the illumination light beam into a direction substantially perpendicular to the extraordinary axis of the birefringent material when the driving voltage is applied.
